(19) United States
(12) Patent Application Publication
(10) Pub. No.: US 2014/0324577 A1
(43) Pub. Date: Oct. 30, 2014

(54) ANONYMOUS ADVERTISING STATISTICS IN P2P NETWORKS

(71) Applicant: THOMSON LICENSING, Issy de Moulineaux (FR)

(72) Inventors: Ashwin Kashyap, Mountain View, CA (US); Dekai Li, San Jose, CA (US); Saurabh Mathur, Danville, CA (US)

(21) Appl. No.: 14/362,290

(22) PCT Filed: Dec. 6, 2011
(86) PCT No.: PCT/US11/63368

§ 371 Date: Jun. 2, 2014

(51) Int. Cl. G06Q 30/02; H04L 29/08

(52) U.S. Cl. CPC G06Q 30/0254; H04L 67/104
USPC 705/14.52

(57) ABSTRACT

An advertising statistics collection system employs multiple peers, a signing server and a collection server to ensure peer privacy when the statistics are gathered. A peer relay system aids in providing anonymity for a given peer in a peer-to-peer network environment with little or no trust between communicating parties. Peers are additionally protected by a randomly generated identifier that can be used to globally gather statistics on the peer without revealing the peer's identity.

### BACKGROUND

Point-to-point (P2P) systems are playing an increasingly important role in the distribution of entertainment content. There are several business models that profitably sustain this type of content distribution. The key advantage of a P2P distribution system is that the bandwidth costs can be reduced, while at the same time both throughput and scalability can be increased. However, this has made obtaining advertising statistics even more challenging.

One business model is to mimic the plain old TV model of content distribution—the content owner is compensated by advertisement revenues. Traditionally, TV stations have gained insight about advertisement placement from such companies as Nielsen that provides marketing information. The basic approach is to randomly sample the viewing population. In order to provide accurate information, it is necessary to deploy a considerable amount of resources. The advantage of a P2P system is that intermediate peer nodes that participate in the content distribution are programmable and can report statistics such as when a content was viewed, what advertisement s were displayed and the like. This data can be aggregated by a suitable entity and the information can be presented to advertisers to help them efficiently target the audience. However, many times this aggregation of data is in opposition with user data privacy policies instituted by companies.

### SUMMARY

The methods and systems relate to privacy aware collection of advertisement statistics in a peer-to-peer environment with little or no trust between communicating parties. This enables an advertiser to target specific demographics by collecting statistics while preserving a user's privacy. The approach is to relay messages in a P2P system such that it reaches a well known final destination after being relayed via a random number of intermediate peers. This ensures that the privacy of the peer that originated the message is protected.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 is an example of a network utilized in an embodiment.

FIG. 2 shows a sequence of messages exchanged (encrypted, authentic & anonymous case).

FIG. 3 is an example of generating authentic anonymous messages.

FIG. 4 depicts a signature server's role.

FIG. 5 illustrates a relaying peer's role.

FIG. 6 shows a collection server's role.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

Most service providers have a privacy policy that they claim to follow when handling sensitive private user data. However, the burden of trust is on the user. There is no provably secure method or protocol or system that is used in order to cryptographically guarantee privacy. The systems and methods disclosed herein can be utilized to solve the advertisement statistics collection and reporting problems.

In many instances, advertisers seek to find important statistics such as: How many times was a particular advertisement watched? At what times was a particular advertisement watched? What content was being watched when a certain advertisement was displayed? Unique number of people who watched a particular advertisement. These questions can be answered in any content distribution system. However, it is hard to provide this information while at the same time protect the user's privacy. Also, most of the schemes require the end user to trust a service provider with conscientiously handling this sensitive information. This is especially harder for the end user to do, in light of the increasing number of online server breaches, identity thefts and such. Thus, systems and methods are provided that are capable of gleaning all of this useful information without trusting others and not compromising privacy.

The approach is to relay messages in a P2P system such that it reaches a well known final destination after being relayed via a random number of intermediate peers. This ensures that the privacy of the peer that originated the message is protected. This relaying is equivalent to an anonymous channel. However, by the nature of TCP/IP communication (or any other point-to-point protocol), the pseudo identity of the peers can be discovered by colluding. This does not disclose the real identity of the peers (like the certificate or public key).

The message being relayed can be piggybacked on other messages such as advertisement and content blocks to reduce frequent communication with the peers. It is also possible to collate several such messages and relay them together and/or for the same message to be relayed multiple times by a peer to increase reliability. However, this might give rise to duplicate messages. Since two independent peers can create identical reports, it is necessary for each message to have a random number that uniquely identifies the message globally without leaking information about the originator.

These systems and methods require the following to be enacted:
Accuracy—An advertisement report cannot be changed or faked.
Privacy—An advertisement report cannot be linked back to the originator.
Verifiability—Each advertisement report can be easily verified for its authenticity.
Accountability—Peers cannot generate advertisement reports freely. In order for a report to be signed, peers should be valid and messages should conform to policy.

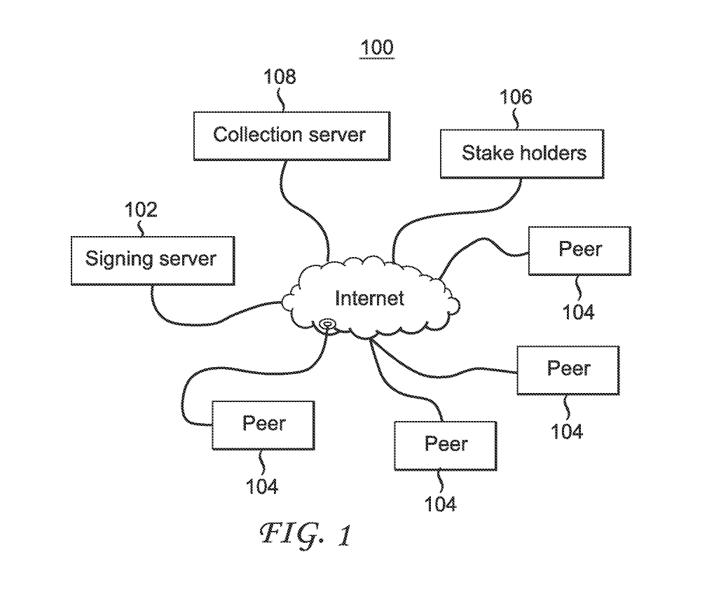

FIG. 1 is an example of a network 100 utilized in one embodiment. It illustrates entities involved in the collection of advertisement data. This includes, for example, a signature server 102 which signs messages, at least one peer 104 that forms a P2P network, at least one stake holder 106 which are entities purchasing advertisement slots, content providers and such and a collection server 108 that collects and aggregates all advertisement statistics, which are presented to the stake holders 106.

Each peer 104 has to first register with a central authority to receive a unique client certificate that must be used to prove its authenticity to the signing server 102 to get any message signed. This process is a onetime thing, and the service provider ensures that this process cannot be automated by bots and also prevents multiple registrations by the same entity. Then let m represent a message that contains a statistics report and a random variable. This ensures that the message is unique without identifying a peer that generated it:
q—a random number generated locally by a peer
m—{advertisement report, q}
   Here, q is the random number that was generated that uniquely identifies m globally in the entire P2P network. There are several algorithms to generate q by using high entropy sources, so the probability of collision is ignored. It is possible for messages to get duplicated while being relayed, the collection server 108 only counts unique reports based on q. The message can be further encrypted and signed to avoid problems like spam and fake messages.

While the above algorithm works, it is very easy for rogue peers to abuse the system and flood it with fake messages. The following section solves the problem by applying some concepts from e-voting and electronic cash that were described originally by D. Chaum in “Blind Signatures for Untraceable Payments.” In order to maintain clarity and simplicity, there are several optimizations that have been left out. In the description below, it is assumed that all these algorithms and protocols are public knowledge and only some required keys are kept secret:
d—decryption or the private key of signature server
e—encryption or the public key of signature server
k—decryption or private key of the collection server, possible to have d=k
p—encryption or public key of the collection server, possible to have p=e
n—a number that is used to derive d, e, p and k.
ENC—a secure asymmetric encrypting function
DEC—inverse of ENC
SIGN—signature function using d, it is assumed that this is to be m^{d} mod n in future discussions. Verification can be done by any entity possessing e.
HASH—a secure hashing function, e.g.: SHA256
r—secret blinding number; random number relatively prime to n. Independent of q.
M—m encrypted with p that can only be decrypted with k
h—hash of the encrypted message, M
h′—the blinded hash, to avoid dictionary attacks by collusion
R₁—the report, {M, s}

Let:
M=ENC(m, p)
h=HASH(M)
s=SIGN(h)=h^{d} mod n

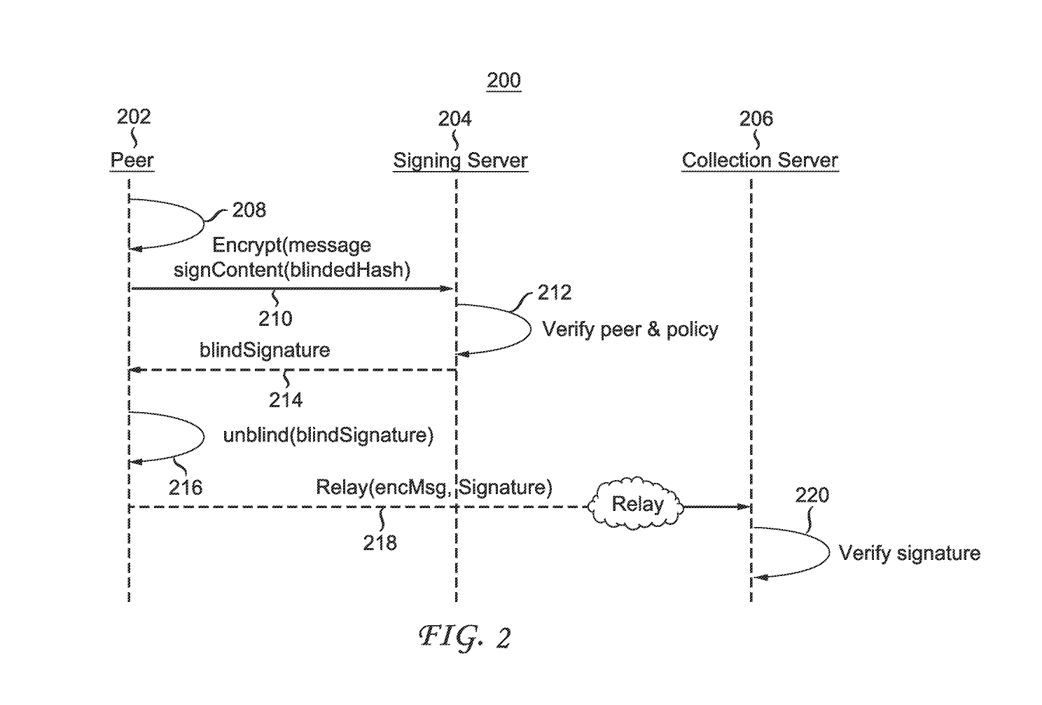

FIG. 2 shows a sequence 200 of messages exchanged (encrypted, authentic & anonymous case). It is referenced for the following discussion. Note that the collection server's keys are used to encrypt but the signing server's keys are used for signing. The signature can be verified by intermediate peers by processing M and e. This ensures that invalid messages are discarded at the earliest. Since it is desirable to prevent a collection server 206 and a signing server 204 from colluding and performing a dictionary attack, a peer 202 shall not provide h to the signing server 204, instead it blinds h as follows:

h′=hr^{e}modn

The peer 202 then sends this 210 to the signing server 204, which signs and returns it 212, 214:

s′=(h′)^{d}modn

The peer 202 verifies the signature was performed correctly, to prevent server from including any other data. At this point h is destroyed and the peer 202 proceeds to derive s from s′ as follows 216:

s′r⁻¹=(h′)^{d}r⁻¹modn=h^{d}r^{ed}r⁻¹modn

The following is true for RSA (Rivest, Shamir and Adleman encryption technique):

r^{ed}=rmodn

So, we have:

s′r⁻¹=h^{d}rr⁻modn=h^{d}modn

∴s′r⁻¹=s

This shows that it is possible to have a blinded message (h′) signed by a trusted third party and then derive the corresponding signature (s), provided r known. Furthermore, if a server decides to log this information, it is useless as there is no computationally feasible way to correlate m and h′.

The peer 202 proves its identity to the server before the message is signed. This can be accomplished by an exchange of client certificates (not shown) and is done to enforce policy. It is also possible to include the blinded message and another clear message together. One example is to include a content identification (ID) in the clear along with h. This can be used to enforce a policy to restrict peers to report once per given content ID (it may sacrifice some privacy). Any such policy can be dictated by the service provider as a condition to signing messages. These policies can have important implications on privacy and accuracy, so it is important to choose a policy that ensures both privacy and accuracy. The system is stable as intermediate peers can verify validity of messages; invalid messages will be discarded thereby preventing DoS attacks.

On receipt of a message 218, the collection server 206 verifies 220 and proceeds to decrypt the message and store it for further processing. The signature is verified as follows:

s^{e}=h^{de}modn=hmodn

Where,

h=HASH(M)

If the signature fails, then the mismatch can be detected and the report is discarded. It then proceeds to decrypt as follows:

m=DEC(M,k)

One of the main problems in current schemes (for example, Google analytics) that collect advertisement statistics is that they are prone to extreme spamming. Spam filtering is only possible because these schemes collect a lot of information without regards to privacy. The systems and methods disclosed herein ensure that privacy is not compromised while still keeping the system spam free.

In an alternative embodiment, the above scheme can be extended to sign a combination of blinded and unblinded messages. First, assume the client wishes to include a plain message so that intermediate peers are able to process it. Let this message be denoted by m₁ and let h₁ denote the hash of m₁. It is assumed that m₁ does not strongly identify the peer in any way but may be globally unique (see TABLE 1 below).

m₁—message to be relayed (plain)

h₁—HASH(m₁)

h_{1′}—blinded h₁

r₁—random number used to blind h₁. Possible to for r₁=r.

h₂, h′₂, r₂—corresponding values for to m₂

h′₃—combined hash of {M, m₃}. Note this scheme is different from above

h′₃, r₃—corresponding values to m₃

Rₘ—final message to relay

In order to simplify the explanation, assume that m₁ is a message for which no anonymity needs to be preserved and m₂ and m₃ are messages that need to have anonymity preserved. From the previous embodiment, m denotes a message for which anonymity must be preserved as well as encrypt it (M) so that intermediate peers are unaware of the contents. In TABLE 1 below, it is outlined how different messages can be authenticated for subsequent relaying, and how they can be combined to form complex messages.

TABLE 1

| | Message | | | |
|---|---|---|---|---|
| Scheme | sent for | Blinded | | |
| description | signature | signature - s′ | Signature - s | To relay |
| Unencrypted | {m₁} | SIGN(h₁) = | s′ = | {m₁, s} |
| with no | | h₁^{d} mod n | h₁^{d} mod n | |
| anonymity | | | | |
| Unencrypted | {h′₂} | SIGN(h′₂) = | s′r₂⁻¹ = | {m₂, s} |
| with | | h₂^{d}r₂^{ed} mod n | h₂^{d} mod n | |
| anonymity | | | | |
| Encrypted | {h′} | SIGN(h′) = | s′r⁻¹ = | {M, s} |
| with | | h^{d}r^{ed} mod n | h^{d} mod n | |
| anonymity | | | | |
| Combination | {h′, m₁} | SIGN (h′, h₁) = | s′r⁻¹ = | {M, m₁, s} |
| 2a | | h^{d}r^{ed}h₁^{d} mod n | h^{d}h₁^{d} mod n | |
| Combination | {h′, h₂′} | SIGN(h′, h₂′) = | s′r⁻¹r₂⁻¹ = | {M, m₂, s} |
| 2b | | h^{d}r^{ed}h₂^{d}r₂^{ed} mod n | h^{d}h₂^{d} mod n | |
| Combination | {h′₃} | SIGN(h′₃) = | s′r₃⁻¹ = | {M, m₃, s} |
| 2c | | h₃^{d}r₃^{ed} mod n | h₃^{d} mod n | |
| Combination | {h′, m₁, h₂′} | SIGN(h′, h₁, h′₂) = | s′r⁻¹r₂⁻¹ = | {M, m₁, m₂, s} |
| 3a | | h^{d}r^{ed}h₁^{d}h₂^{d}r₂^{ed} mod n | h^{d}h₁^{d}h₂^{d} mod n | |

TABLE 1 legend:
Message sent for signature - this is the message transmitted to the signing server
Blinded signature - s′ - This is the signature returned by the signing server
Signature - s - This is the signature derived by the peer from s′.

The first case is included for illustration, it does not make sense to anonymously relay m₁ when the server already knows the content! Note that the signature for multiple messages is for the combined message so it is not possible to split and uncombine messages after signature as the signature will be invalid. However, intermediate peers can still verify the authenticity of the messages by processing the message and signature appropriately provided the scheme is known.

The ENC function must be chosen carefully to prevent certain attacks. SIGN(ENC(m, p), d) will put the message in clear (if the collection server and the signing server share keys). The problem does not manifest above as we are hashing M and the blinded digest is signed. You also do not want to leak m to intermediate peers. ENC is chosen suitably. One method is to use a symmetric encryption function with a random key, then use p to encrypt this random key and include it as well. A necessary property is that if a message is encrypted with p then it can only be decrypted with k.

Messages are relayed in the network until “expired.” Here the definition of expired can be defined in different ways, depending on needs. In the following section, some methods were defined to determine when a message relaying must be stopped and the report sent to the collection server. For this to work, messages should include information so that intermediate peers are able to make an appropriate decision.

The following presents a very simple but insecure algorithm that ensures that the privacy of the originating peer is protected, even on the first relay hop:

c—Down counter, initialized to a random value and decremented randomly every hop.

R₂—{M, s, c}, basically R₁ with a down counter.

When the originating node relays the message, a random number is included with the message (suitably chosen with the maximum hop count in mind). When the message is relayed for the first time, it is impossible for the receiving peer to determine where the message originated since c is random. When the message is subsequently relayed, the counter is decremented by a small random value (again, suitably chosen so the message is relayed a few hops). If the counter reaches <=0, the peer holding the message stops relaying and sends it to the collection server. This guarantees that the message origination is kept secret.

A problem with the above approach is that it is easy for rogue peers to tamper with c. This can easily be exploited to cause a DoS (denial of service) attack. The following describes a method where expiry time is used instead of a decrementing counter. This expiry time is signed along with h₄. This is an elaboration of the “Combination 2c” scheme described previously in TABLE 1.

Let:

t—expiry time of the message (included in the packet in the clear)

h₄—hash of {M, t}

h′₄—blinded hash

s₄—signature of h₄

s′₄—blinded signature

R₄—{M, t, s₄} the report to be transmitted via relay

By definition:

h₄=HASH({M,t})

h′₄=h₄r^{e} mod n

s₄=SIGN(h₄)

s′₄=SIGN(h′₁)

The peer generates a hash h₄ for the encrypted message and the expiry time t included together. This is then blinded (h′₄) and sent to the signing server for signature. The report is constructed after unblinding s′₄ and deriving s₄. R₄ is then relayed. Intermediate peers keep relaying the report until the expiry time t is in the future. When the message expires, it is sent to the collection server. Some form of time synchronization between peers is needed for this to work reliably. Also, validity of the report can be checked as usual; intermediate peers can also check policy to ensure that t is valid and within bounds—they can drop non-conforming messages.

The embodiments disclosed can be extended to any type of report where confidentiality needs to be maintained (for e.g., peer's log reports). A cryptographically secure method is disclosed to generate authenticated messages and subsequently report them to a central authority in an anonymous fashion.

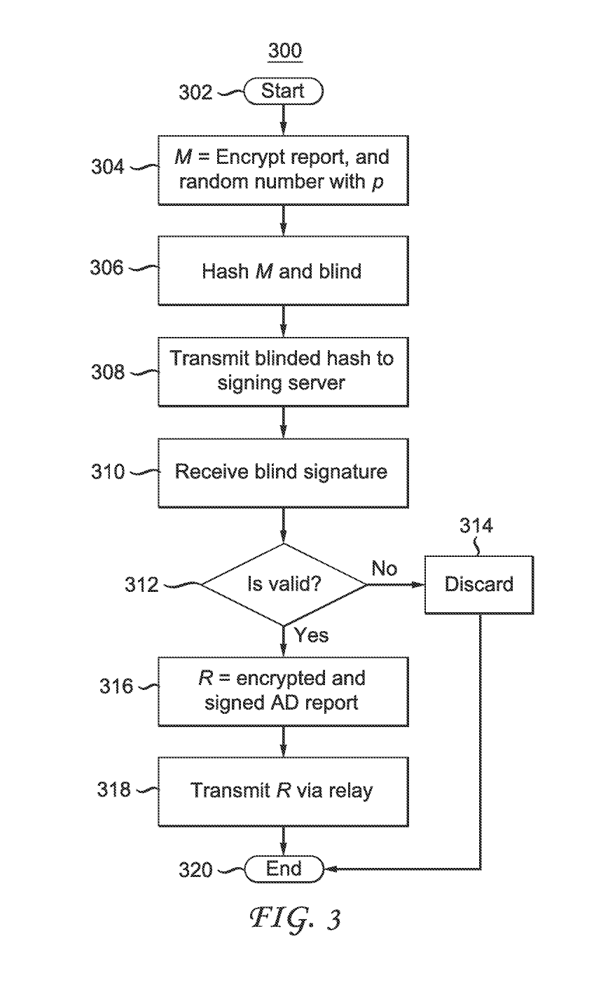

In view of the exemplary embodiments shown and described above, methodologies that can be implemented in accordance with the embodiments will be better appreciated with reference to the flow charts of FIGS. 3-6. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 3 is a flow diagram of a method 300 of generating anonymous messages. The method starts 302 by encrypting a report and generating a random number (usually accomplished by a peer) 304. The encrypted report is then hashed and made blind 306. The peer transmits the blinded has to a signing server along with a signature 308. The signing server receives the blind signature 310 and determines if it is valid 312. If not valid, it is discarded 314, ending the flow 320. If valid, an encrypted and signed advertisement (AD) report is generated 316 and then transmitted via a peer relay to a collection server 318, ending the flow 320.

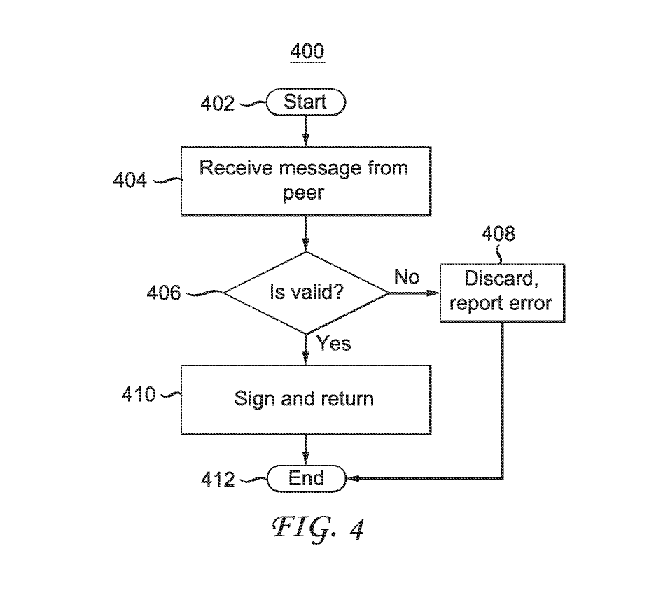

FIG. 4 is a flow diagram of a method 400 of a signature server's role in relation to an embodiment. The method starts 402 by a signing server receiving a message from a peer 404. The signing server then determines if the message is valid 406. If not, the message is discarded and/or an error is reported back to the peer 408, ending the flow 412. If valid, the message is signed and sent back to the peer 410, ending the flow 412.

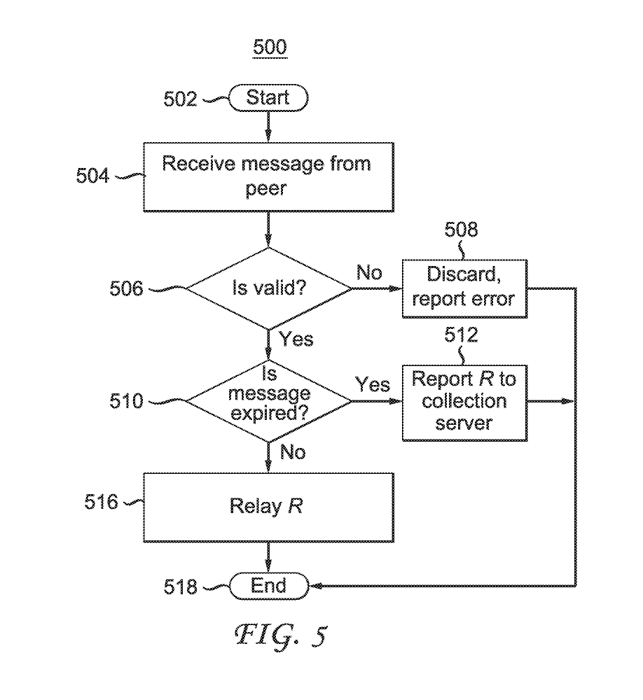

FIG. 5 is a flow diagram of a method 500 that illustrates a relaying peer's role in an embodiment. The relaying facilitates in providing privacy for a sending peer. The method 500 starts 502 by a peer receiving a message from another peer 504 and determines if the message is valid 506. If not, the message is discarded and/or an error report is sent back to the sending peer 508, ending the flow 518. If valid, the peer determines if the message has expired 510. If expired, the peer sends the message containing an advertising report to a collection server 512, ending the flow 518. If the message is not expired, the peer relays the advertising report to another peer and/or to a collection server, 516, ending the flow 518.

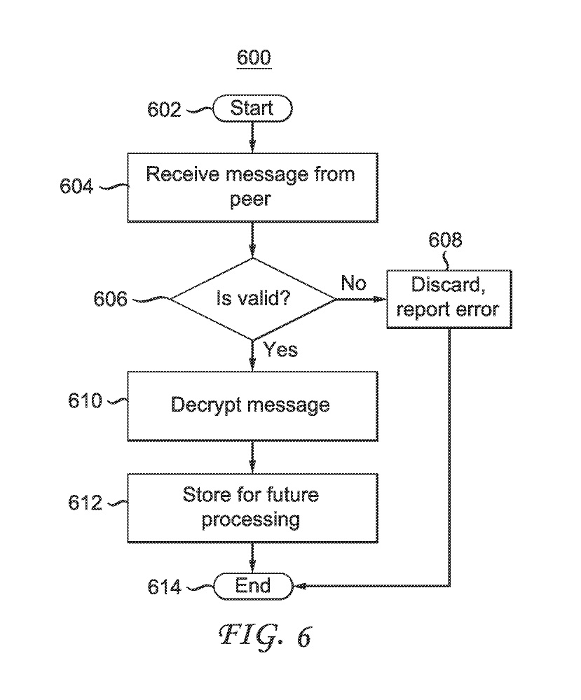

FIG. 6 is a flow diagram of a method 600 that shows a collection server's role in an embodiment. The method 600 starts 602 by a collection server receiving a message from a peer 604. The collection server then determines if the message is valid 606. If not, the message is discarded and/or an error is reported to the peer 608, ending the flow 614. If valid, the collection server decrypts the message 610 and stores it for future processing 612, ending the flow 614.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that collects advertising statistics, comprising:
a plurality of peers in a peer-to-peer network, each peer having its own random identifier and retains a signature for advertising statistic network messages;
a signing server that interfaces with at least one peer to verify its signature; and
a collection server that receives signed messages sent from a peer and relayed from peer-to-peer to the server.

2. The system of claim 1, wherein the peer generates its own random identifier.

3. The system of claim 1, wherein the collection server discards peer messages for at least one of an expired message and a message with an invalid signature.

4. The system of claim 1, wherein the signing server discards peer messages with an invalid signature.

5. The system of claim 4, wherein a peer used in relaying a message to the collection server discards a message when it is invalid.

6. A method for collecting advertising statistics, comprising:
selecting a random identifier for at least one peer in a peer-to-peer network;
attaching the random identifier to a network message containing advertising statistics relating to a given peer; and
relaying the network message from peer to peer to reach a known destination.

7. The method of claim 6, wherein the selection of the random identifier is accomplished in a peer.

8. The method of claim 6, further comprising:
communicating with a signing server to establish a correct signature for the peer.

9. The method of claim 8, further comprising:
attaching the signature of the peer to the network message before relaying it to the known destination.

10. The method of claim 6, wherein the known destination is a collection server.

11. A system that collects advertising statistics, comprising:
a means for selecting a random identifier for at least one peer in a peer-to-peer network;
a means for attaching the random identifier to a network message containing advertising statistics relating to a given peer; and
a means for relaying the network message from peer to peer to reach a known destination.

12. The system of claim 11 further comprising:
a means for communicating with a signing server to establish a correct signature for the peer; and
a means for attaching the signature of the peer to the network message before relaying it to the known destination.
